(19) United States
(12) Patent Application Publication
(10) Pub. No.: US 2022/0204731 A1
(43) Pub. Date: Jun. 30, 2022

(54) Modulus Recovery In Silica-Containing Tire Treads

(71) Applicant: Bridgestone Americas Tire Operations, LLC, Nashville, TN (US)

(72) Inventor: Seth M. Miller, Wooster, OH (US)

(73) Assignee: Bridgestone Americas Tire Operations, LLC, Nashville, TN (US)

(21) Appl. No.: 17/646,321

(22) Filed: Dec. 29, 2021

Related U.S. Application Data
(60) Provisional application No. 63/132,532, filed on Dec. 31, 2020.

(51) Int. Cl. C08L 9/06; C08L 7/00; C08K 5/00; C08K 5/44; C08K 3/013; C08K 3/04; C08K 3/36; B60C 1/00

(52) U.S. Cl. CPC C08L 9/06; C08L 7/00; C08K 5/0025; C08K 5/44; B60C 2200/06; C08K 3/04; C08K 3/36; B60C 1/0016; C08K 3/013

(57) ABSTRACT

A heavy vehicle tire tread that contains a rubber component and a reinforcing filler that includes silica and a second filler. A first and second vulcanization accelerator are used together with sulfur and a silane coupling agent in the tire tread, wherein the 300% modulus of the tire tread is 8 MPa or more. The silane coupling agent, sulfur and total reinforcing filler content in the tire tread composition are present in a ratio range of 1:0.4:0.4 to 1:1.4:1.4.

This application claims the benefit of U.S. Provisional Application Ser. No. 63/132,532 filed Dec. 31, 2020, the contents of which are incorporated herein in their entirety by reference.

### TECHNICAL FIELD

The present disclosure relates to heavy vehicle tire treads having a silica content and, in particular, to heavy vehicle tire treads having selective modulus properties comparable to tire treads free of silica filler.

### BACKGROUND

Improvement of performance and wear characteristics of tire treads is often a trade off since increasing resistance to wear can decrease performance, rolling and heat resistance. Composition ingredients are selected for potential impact on the properties of a tire. For heavy vehicle tire treads, choice of reinforcement fillers has focused on carbon blacks and, less frequent, silicas have been utilized for desired performance characteristics. Silica can delay rubber curing reactions as compared to the use of carbon black, which can impact performance characteristics of a tire tread.

There is a need for rubber compositions that provide heavy vehicle tire treads having an improved combination of wear performance and rolling resistance. The present invention employs a combination of materials that provide a silica-containing heavy vehicle tire tread having similar performance characteristics of non-silica tread compositions.

### SUMMARY

In a first aspect, disclosed is a heavy vehicle tire tread formed from a rubber composition, the rubber composition having a rubber component and, per 100 parts by weight of rubber, of a reinforcing filler with silica at less than 30 phr, a silane coupling agent, 0.5 to 2.5 phr sulfur, 0.5 phr or more of a first vulcanization accelerator; and optionally a second vulcanization accelerator, wherein a ratio of the silane coupling agent to the sulfur to total accelerator content is in the range of 1:0.6:0.6 to 1:1.4:1.4 and the tire tread has a modulus 300% elongation of the tire tread is 8 MPa or more.

In an example of aspect 1, the reinforcing filler includes 28 phr or less of silica, for example, 1-28 phr of silica.

In another example of aspect 1, the ratio of the silane coupling agent to the total sulfur (e.g., free sulfur) is greater than 1:0.6, wherein the ratio of the total sulfur to total accelerator content is 1:0.9 to 1:1.3, or 1:0.95 to 1:1.25, or greater than 1:1.

In another example of aspect 1, the sulfur is present at 1-2 phr and the silane coupling agent is present at 0.5 to 4.5 phr, 0.6 to 4 phr, 0.7 to 3 phr, or 0.8 to 2.5 phr.

In another example of aspect 1, the primary accelerator is a sulfenamide, and the ratio of the sulfur to the sulfenamide is 1:0.65 to 1:1.2.

In another example of aspect 1, the second vulcanization accelerator is present in an amount of 0.35 phr or more.

In another example of aspect 1, the first vulcanization accelerator and the second vulcanization accelerator are present at a ratio from 1:1 to 4:1.

In another example of aspect 1, the ratio of the silane coupling agent to the sulfur is from 0.75:1 to 3:1.

In another example of aspect 1, the reinforcing filler further includes carbon black, and the reinforcing filler has a ratio of the silica to the carbon black of from 1:1 to 12.5:1.

In another example of aspect 1, the reinforcing filler includes 1 to 35 phr of carbon black.

In another example of aspect 1, the total content of the first vulcanization accelerator and the second vulcanization accelerator is in the range of 1.5 to 2.5 phr.

In another example of aspect 1, the rubber component includes 40 to 100 parts by mass of a natural rubber or a polyisoprene rubber.

In another example of aspect 1, the rubber component further contains a diene elastomer, for example, polybutadiene rubber or a polystyrene-butadiene rubber.

In another example of aspect 1, the tire tread is a truck tire tread or a bus tire tread.

In a second aspect, there is a heavy vehicle tire tread formed from a rubber composition, the rubber composition includes a rubber component, the rubber component containing 50-90 phr of natural rubber or a polyisoprene rubber and 10-50 phr of a diene elastomer, and, per 100 parts by weight of rubber, of a reinforcing filler that includes 30-50 phr of silica, 2-4 phr silane coupling agent, 1-2.5 phr sulfur, 1 phr or more of a first vulcanization accelerator and a second vulcanization accelerator, wherein a ratio of the silane coupling agent to the sulfur to total accelerator content in the composition is in the range of 1:0.4:0.4 to 1:0.8:0.8, wherein a modulus 300% elongation of the tire tread is 8 MPa or more.

In an example of aspect 2, the reinforcing filler contains 35 phr or less of carbon black.

In another example of aspect 2, the first vulcanization accelerator and the second vulcanization accelerator are present at a ratio from 1.2:1 to 2.5:1.

In another example of aspect 2, the primary accelerator is a sulfenamide, and the ratio of the sulfur to the sulfenamide is 1:0.6 to 1:0.9.

In another example of aspect 2, the sulfenamide is present at 1-1.5 phr.

In another example of aspect 2, the sulfur is present at 1.5-2 phr and the silane coupling agent is present at 2.8 to 3.8 phr.

In another example of aspect 2, the total content of the first vulcanization accelerator and the second vulcanization accelerator is in the range of 1.5 to 2.5 phr.

Any one of the above aspects (or examples of those aspects) may be provided alone or in combination with any one or more of the examples of that aspect discussed above; e.g., the first aspect may be provided alone or in combination with any one or more of the examples of the first aspect discussed above; and the second aspect may be provided alone or in combination with any one or more of the examples of the second aspect discussed above; and so-forth.

Additional features and advantages will be set forth in the detailed description which follows, and in part will be readily apparent to those skilled in the art from that description or recognized by practicing the embodiments as described herein, including the detailed description which follows, the claims. It is to be understood that both the foregoing general description and the following detailed description are merely exemplary, and are intended to provide an overview or framework to understanding the nature and character of the claims.

### DETAILED DESCRIPTION

The terminology as set forth herein is for description of the embodiments only and should not be construed as limiting the invention as a whole.

Herein, when a range such as 5-25 (or 5 to 25) is given, this means preferably at least or more than 5 and, separately and independently, preferably not more than 25. In an example, such a range defines independently at least 5, and separately and independently, not more than 25.

The terms “substantial,” “substantially,” and variations thereof as used herein are intended to note that a described feature is equal or approximately equal to a value or description. For example, a “substantially planar” surface is intended to denote a surface that is planar or approximately planar. It also is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The present disclosure relates to tire tread for a heavy vehicle tire. The tire tread can be a tread portion for contacting a road surface or an under-tread portion arranged directly below a surface-contacting tread, for instance, adjacent a belt area in the crown. The tire treads are suitable for use in tires for heavy vehicles. Heavy vehicles include, but are not limited to, trucks (e.g., tractor-trailer semitruck), tractors, agricultural equipment, trailers, buses, aircrafts, off-the-road vehicles (e.g., earth movers, dump trucks), and the like. In one or more embodiments, the tire treads for heavy vehicles do not include and are not suitable, or intended for use with passenger vehicles (e.g., cars, vans, motorcycles) and conventional light duty vehicles.

The heavy vehicle tire treads are made of a rubber composition. The tire tread composition has a rubber component, for example, containing one, two or more rubber compounds. Both synthetic and natural rubber may be employed within the rubber compositions of the tire tread. These rubbers, which may also be referred to as elastomers, include, without limitation, natural or synthetic poly(isoprene), with natural polyisoprene being preferred, and elastomeric diene polymers including polybutadiene and copolymers of conjugated diene monomers with at least one monoolefin monomer. The synthetic polyisoprenes include, for example, synthetic cis-1,4 polyisoprene. An example polybutadiene rubber is elastomeric and has a 1,2-vinyl content of 1 to 3 percent and a cis-1,4 content of 96 to 98 percent. Another example polybutadiene rubber has a low cis-1,4 content (e.g., less than 95 or 90 percent). Other butadiene rubbers, having up to 12 percent 1,2-content, may also be suitable with appropriate adjustments in the level of other components, and thus, substantially any high vinyl, elastomeric polybutadiene can be employed. The copolymers may be derived from conjugated dienes such as 1,3-butadiene, 2-methyl-1,3-butadiene-(isoprene), 2,3-dimethyl-1,2-butadiene, 1,3-pentadiene, 1,3-hexadiene and the like, as well as mixtures of the foregoing dienes. The preferred conjugated diene is 1,3-butadiene.

Regarding the monoolefinic monomers, they include vinyl aromatic monomers such as styrene, alpha-methyl styrene, vinyl naphthalene, vinyl pyridine and the like as well as mixtures of the foregoing. The copolymers may contain up to 50 percent by weight of the monoolefin based upon total weight of copolymer. The preferred copolymer is a copolymer of a conjugated diene, especially butadiene, and a vinyl aromatic hydrocarbon, especially styrene (e.g., polystyrene-butadiene rubber).

The above-described copolymers of conjugated dienes and their method of preparation are well known in the rubber and polymer arts. Many of the polymers and copolymers are commercially available. It is to be understood that practice of the present invention is not to be limited to any particular rubber included hereinabove or excluded.

In one or more embodiment, the heavy vehicle tire tread can include a rubber component containing natural rubber or a polyisoprene rubber. In one example, the natural rubber, synthetic polyisoprene rubber, or a combination thereof, is present in the rubber component in an amount of 40 to 100, 50 to 90, 60 to 85, or 65 to 80 parts by mass of the rubber component or parts by weight per hundred parts by weight of the total elastomer (phr), and optionally one or more other elastomers. In another example, the rubber component of the heavy vehicle tire tread includes natural rubber in an amount of 50 to 90 phr or parts by mass of the rubber component, and optionally one or more non-natural rubber elastomers (e.g., a diene elastomer). In another example, the rubber component of the heavy vehicle tire tread includes a first component of natural rubber, synthetic polyisoprene rubber, or a combination thereof and a second component of a diene elastomer. The diene elastomer, or combination of diene elastomers, can be present in the rubber component of the heavy vehicle tire tread in an amount of 5 to 50, 10 to 45, 15 to 40, or 20 to 35 phr or parts by mass of the rubber component.

The heavy vehicle tire tread includes one or more or a blend of reinforcing fillers. In one or more embodiments, the heavy vehicle tire tread is made from a composition that has a total reinforcing filler content in an amount of 30 to 80 phr, 35 to 65 phr, or 40, 45, 50, 55 or 60 phr. The reinforcing filler content in the tire tread composition can include more than one reinforcing filler, for example, at least two fillers, e.g., a first reinforcing filler and a second reinforcing filler, wherein one of the reinforcing fillers is silica. The first and second reinforcing fillers can be different from one another. The first reinforcing filler (e.g., silica) can be present in an amount in the range of 1 to 60 phr, 5 to 50 phr, 10 to 40 phr, 15 to 30 phr, or 20, or 25 phr. The second reinforcing filler (e.g., carbon black) can be present in an amount in the range of 1 to 50 phr, 5 to 40 phr, 10 to 30 phr, or 15, 20 or 25 phr.

The surface of the carbon black and/or silica may optionally be treated or modified to improve the affinity to particular types of polymers. Such surface treatments and modifications are well known to those skilled in the art.

Additional fillers may also be utilized, including but not limited to, mineral fillers, such as clay, talc, aluminum hydrate, aluminum hydroxide and mica. The foregoing additional fillers are optional and can be utilized in varying amounts from 1 phr to 40 phr.

In one or more embodiments, a reinforcing filler can include one or more suitable carbon blacks. Suitable carbon blacks are any conventional carbon blacks, for example, HAF, ISAF and SAF type carbon blacks. Further examples of carbon blacks include N115, N134, N234, N299, N330, N339, N343, N347 and N375 type carbon blacks. Carbon black fillers have a nitrogen specific surface area N₂SA, for example, in the range of 70 to 150 m²/g. In another example, the carbon black reinforcing filler has a dibutyl phthalate absorption, for instance, of 60 to 140 ml/100 g. A reinforcing filler can be selected that has one or more of the above characteristics and, for example, all of the noted properties or various combinations thereof. When present in the reinforcing filler, carbon black is in the amount of 1 to 50, 5 to 45, 10 to 40, or 15 to 35 phr.

The reinforcing filler includes silica, for example, optionally in combination with a non-silica filler such as carbon black. The silica can be any conventional suitable silica. Suitable silicas include precipitated or pyrogenic silica, wet silica (hydrated silicic acid), dry silica (anhydrous silicic acid), calcium silicate, and the like. Among these, precipitated amorphous wet-process, hydrated silicas are preferred. The silica can have a BET surface area and a specific CTAB surface area, for example, 500 m²/g or less, or in the range of 50 to 400, or 100 to 200 m²/g. Some of the commercially available silicas which can be used include, but are not limited to, HiSil 190, HiSil 210, HiSil 215, HiSil 233, HiSil 243, and the like, produced by PPG Industries (Pittsburgh, Pa.). A number of useful commercial grades of different silicas are also available from DeGussa Corporation (e.g., VN2, VN3), Rhone Poulenc (e.g., Zeosil 1165 MP0), and J. M. Huber Corporation. In one example, the silica is present in the reinforcing filler at an amount of 1 to 30 phr, 2 to 28 phr, 5 to 25 phr, 10 to 20 phr, or 15 phr, optionally in combination with another non-silica reinforcing filler. In another example, the silica is present in the reinforcing filler at an amount of 30 to 50 phr, 30 to 45 phr, or 35 to 40 phr, optionally in combination with another non-silica reinforcing filler.

In one or more embodiments, a blend of reinforcing fillers can be present in the heavy vehicle tire tread composition in a select weight percent or phr ratio, for example, a first reinforcing filler (e.g., silica) can be present in a phr ratio to a second reinforcing filler (e.g., carbon black) in a range of 9:1 to 0.25:1, 4:1 to 0.5:1, 3:1 to 1.5:1 or 1:1.

The heavy vehicle tire tread can include a coupling agent, for example silane, when silica or some other type of inorganic particles are used as a reinforcing filler. In such embodiments, the silane coupling agent can help aid bonding of the filler (e.g., silica) to the elastomer. Examples of suitable silane coupling agents include, but are not limited to, functionalized polysulfide silanes, organosulfide polysulfides and organoalkoxymercaptosilanes, bis(trialkoxysilylorgano) polysulfide silanes and thiocarboxylate functional silanes. The amount of coupling agent in the rubber composition can be based on the weight of the silica in the composition, and may be from about 0.1% to about 20% by weight of silica, from about 1% to about 15% by weight of silica, or alternatively from about 1% to about 10% by weight of silica. In another example, the coupling agent can be present in the rubber composition in the range of 0.1 to 5 phr, 0.3 to 4.5 phr, 0.5 to 4 phr, 0.5 to 3.6 phr, 0.8 to 3 phr, or 1, 1.5, 2, 2.2 or 2.5 phr.

Accelerators are used to control the time and/or temperature required for vulcanization and to improve the properties of the vulcanizate. When the rubber composition contains silica, the surface chemistry of silica can interact with curing reaction. The use of an accelerator in non-heavy vehicle rubber compositions can be used to diminish the interaction that silica can produce to provide a cure rate that is comparable to a rubber composition with only carbon black as the filler. For heavy vehicle tread compositions, the use of accelerators has been found to be less effective and static modulus can be up to fifty percent lower as compared to the same rubber composition containing all carbon black filler. It has been found that the addition of sulfur (e.g., free sulfur) at a ratio of about twenty percent of the silane coupling agent loading in combination with an accelerator can substantially maintain the static modulus of a silica-containing heavy vehicle tread composition as compared the same composition containing carbon black in place of the silica reinforcing filler.

The rubber composition can include the presence of a sulfur vulcanizing agent, for example, elemental sulfur or free sulfur. The sulfur agent is used in an amount ranging from 0.5 to 4 phr, 0.8 to 3 phr, 1 to 2.5 phr, 1.2 to 2.2 phr, or 1.3, 1.4, 1.5, 1.6, 1.7, 1.8, 1.9, 2 or 2.1 phr. In one or more embodiments, the amount of sulfur vulcanizing agent present in the rubber composition is related to the content of the silane coupling agent. For instance, the ratio of silane coupling agent to the sulfur vulcanizing agent is in the range of 0.75:1 to 3:1, 0.8:1 to 2.75:1; 0.85:1 to 2.5:1; 0.9:1 to 2:1; 1:1.4 to 1:0.6, or 2.1:1.65, 2.1:1.35, 2:1.5, 1:1.3, 3:1.7 or 3.5:2.

As mentioned above, the sulfur vulcanizing agent is used in combination with one or more accelerators or vulcanization accelerators. In one embodiment, a single vulcanization accelerator system may be used, which in such case would comprise a first or primary vulcanization accelerator. A primary vulcanization accelerator is used, for example, in total amounts ranging from 0.3 to 2.5 phr, 0.5 to 2 phr, 0.8 to 1.8 phr, or 0.9, 1, 1.1, 1.2, 1.3, 1.4, 1.5, 1.6, or 1.7 phr. In one or more embodiments, the primary vulcanization accelerator present in the rubber composition is related to the content of the sulfur vulcanizing agent. For instance, the ratio of primary vulcanization accelerator to the sulfur vulcanizing agent is in the range of 1:0.6 to 1:1.2, 1:0.7 to 1:1.1 or 1:0.8 to 1:1. The primary vulcanization accelerator can be any suitable type of vulcanization accelerator, for example, amines, disulfides, guanidines (DPG), thioureas, thiurams, sulfenamides, dithiocarbamates, xanthates, and sulfenamides. The primary accelerator may also be a thiazole, such as a benzothiazole-based accelerator. Exemplary benzothiazole-based vulcanization accelerators may include N-cyclohexyl-2-benzothiazole sulfenamide (CBS), N-tert-butyl-2-benzothiazole sulfenamide (TBBS), 4-oxydiethylene-2-benzothiazole sulfenamide (OBTS), N,N′-dicyclohexyll-2-benzothiazole sulfonamide (OCBS), 2-mercaptobenzothiazole (MBT), and dibenzothiazole disulfide (MBTS)

In another embodiment, combinations of a primary and a second or secondary vulcanization accelerator might be used with the secondary vulcanization accelerator being used in equal or smaller amounts as compared to the primary vulcanization accelerator. A secondary vulcanization accelerator is used, for example, in total amounts ranging from 0.1 to 1.5 phr, 0.2 to 1.2 phr, 0.3 to 1.1 phr, or 0.4, 0.5, 0.6, 0.7, 0.9 or 1 phr. In one or more embodiments, the secondary vulcanization accelerator present in the rubber composition is related to the content of the primary vulcanization accelerator. For instance, the ratio of primary vulcanization accelerator to the secondary vulcanization accelerator is in the range of 1:1 to 4:1, 1.5:1 to 3.5:1 or 2:1 to 3:1. The secondary vulcanization accelerator can be any suitable type of accelerator, for example, those noted above for the primary vulcanization accelerator. In one or more embodiments, the secondary vulcanization accelerator can be a guanidine compound, for instance, diphenyl guanidine (DPG) and the like; thiuram vulcanizing accelerators; carbamate vulcanizing accelerators; and the like.

The total amount of vulcanization accelerators (e.g., the primary and the secondary vulcanization accelerators), excluding any free sulfur, in the rubber composition can be amounts ranging from 0.8 to 5 phr, 1 to 4 phr, 1.2 to 3 phr, or 1.4, 1.5, 1.6, 1.8, 2, 2.2, 2.4, 2.5, 2.6 or 2.8 phr. The total amount of vulcanization accelerator can be expressed relative to the amount of silane coupling agent and sulfur (free sulfur present) in the rubber composition. For example, the ratio of silane coupling agent to the sulfur to the total vulcanization accelerator content in is the range of 1:0.4:0.4 to 1:1.4:1.4, 1:0.6:0.6 to 1:1.2:1.2, or 1:0.8:0.8 to 1:1:1.

Other ingredients that may be employed in the rubber compositions of certain embodiments disclosed herein are well known to those of skill in the art and include oils (processing and extender), waxes, processing aids, tackifying resins, reinforcing resins, peptizers, and one or more additional rubbers.

Various types of processing and extender oils may be utilized, including, but not limited to aromatic, naphthenic, and low PCA oils. In one or more embodiments, the total amount of oil used (processing oil and extender oil) in the rubber compositions and methods disclosed herein ranges from 1 to 70 phr, 2 to 60 phr, or 3 to 50 phr.

Various antioxidants are known to those of skill in the art and may be utilized in the rubber compositions of certain embodiments; these include but are not limited to phenolic antioxidants, amine phenol antioxidants, hydroquinone antioxidants, alkyldiamine antioxidants, and amine compound antioxidants such as N-phenyl-N′-isopropyl-p-phenylenediamine (IPPD), or N-(1,3-dimethylbutyl)-N′-phenyl-phenylenediamine (6PPD). One or more than one type may be utilized in certain embodiments, the total amount of antioxidant(s) used is 0.1 to 6 phr.

Also disclosed herein are methods for preparing rubber compositions. The rubber compositions may generally be formed by mixing together the ingredients for the rubber composition (as disclosed above) by methods known in the art, such as, for example, by kneading the ingredients together in a Banbury mixer or on a milled roll. The methods generally include at least one non-productive master-batch mixing stage and a final productive mixing stage. The term non-productive master-batch stage is known to those of skill in the art and generally understood to be a mixing stage where no vulcanizing agents or vulcanization accelerators are added. In certain embodiments of the compositions and methods disclosed herein, more than one non-productive master-batch mixing stage may be used. The term final productive mixing stage is also known to those of skill in the art and generally understood to be the mixing stage where the vulcanizing agents and vulcanization accelerators are added into the rubber composition.

In certain embodiments of the methods for preparing rubber compositions according to the embodiments disclosed herein, the non-productive master batch mixing stage(s) may be conducted at a temperature of about 130° C. to about 200° C. In certain embodiments, the final productive mixing stage may be conducted at a temperature below the vulcanization temperature in order to avoid unwanted pre-cure of the rubber composition. Therefore, the temperature of the productive mixing stage should not exceed about 120° C. and is typically about 40° C. to about 120° C., or about 60° C. to about 110° C. and, especially, about 75° C. to about 100° C.

With respect to certain embodiments disclosed herein, the list of ingredients should be understood as including ingredients to be mixed to form the rubber composition. With respect to other embodiments disclosed herein (i.e., a rubber composition that has been subjected to curing), the list of ingredients should be understood to comprise the ingredients present in the cured rubber composition.

As previously discussed, certain embodiments disclosed herein include tires, and tire treads comprising a rubber composition of the second embodiments as otherwise disclosed herein, i.e., comprising at least one rubber, silica (e.g., above 30 phr), a silane coupling agent, 0.5 to 2.5 phr of sulfur, and one or more vulcanization accelerators, and a ratio of the silane coupling agent to the sulfur to total accelerator content is in the range of 1:0.6:0.6 to 1:1.4:1.4. More specifically, the present disclosure includes a tire comprising a rubber composition of the embodiments as otherwise disclosed herein, a tire comprising a tire tread comprising a rubber composition of the embodiments as otherwise disclosed herein, and a tire tread comprising a rubber composition of the embodiments as otherwise disclosed herein. Generally, when the rubber compositions of the embodiments disclosed herein are utilized in tires, tire treads, or other components, these compositions are processed into tire components according to ordinary tire manufacturing techniques including standard rubber shaping, molding, and curing techniques. Any of the various rubber tire components can be fabricated including, but not limited to, treads. Typically, vulcanization of a tire component is effected by heating the vulcanizable composition in a mold; e.g., it may be heated to about 140° C. to about 180° C. Cured or crosslinked rubber compositions may be referred to as vulcanizates, which generally contain three-dimensional polymeric networks that are thermoset. The other ingredients, such as processing aides and fillers, may be evenly dispersed throughout the vulcanized network. In certain embodiments, pneumatic tires containing the rubber compositions as disclosed herein can be produced as discussed in U.S. Pat. Nos. 5,866,171, 5,876,527, 5,931,211, and 5,971,046, which are incorporated herein by reference.

In order to demonstrate the practice of the present invention, the following examples have been prepared and tested. The examples should not, however, be viewed as limiting the scope of the invention. Numerous variations over these specific examples are possible without departing from the spirit and scope of the presently disclosed embodiments. More specifically, the particular rubbers, fillers, and other ingredients (e.g., curative package ingredients and accelerators) utilized in the following examples should not be interpreted as limiting since other such ingredients consistent with the disclosure in the Detailed Description can be utilized in substitution. In other words, the particular rubbers, fillers, and other ingredients as well as their amounts and their relative amounts in the following examples should be understood to apply to the more general content of the Detailed Description.

### Example 1

Table 1 below lists the components of sample tread rubber compositions that were made to determine the composition properties at various loadings of silica, silane coupling agent, sulfur, and vulcanization accelerators. Composition A, as compared to Compositions B-F, is the reference compositions containing only carbon black filler and no silica. Compositions B-F contain a constant amount of both carbon black and silica. All of the charges are listed as parts per hundred rubber (phr). All of the compounded final sample stocks were sheeted and subsequently cured at 145° C. for 33 minutes.

TABLE 1

| | Comp. | Comp. | Comp. | Comp. | Comp. | Comp. |
|---|---|---|---|---|---|---|
| Component | A | B | C | D | E | F |
| Natural Rubber | 80 | 80 | 80 | 80 | 80 | 80 |
| Butadiene | 20 | 20 | 20 | 20 | 20 | 20 |
| Rubber | | | | | | |
| Carbon Black | 43 | 17 | 17 | 17 | 17 | 17 |
| Silica | 0 | 26 | 26 | 26 | 26 | 26 |
| Silane | 0 | 2.08 | 2.08 | 2.08 | 2.08 | 2.08 |
| Coupling | | | | | | |
| Agent | | | | | | |
| Sulfur | 1 | 1 | 1.64 | 1.34 | 1.64 | 1.34 |
| Accelerator 1 - | 1 | 1 | 1.69 | 1.38 | 1.69 | 1.38 |
| sulfonamide | | | | | | |
| Accelerator 2 - | 0 | 0.5 | 0 | 0 | 0.5 | 0.5 |
| guanidine | | | | | | |

Table 2 below lists the properties (e.g., tensile) after cure of the sample tread rubber compositions (Compositions A-F) of Table 1. The abbreviation Eb is used for elongation at break and Tb for stress at break, which measurements provide an indication of a rubber composition's tear resistance, which is particularly relevant when it is incorporated into a tire tread. The abbreviations M50 and M300 are used for tensile stress or tensile moduli at 50% and 300% elongation. The abbreviation E′ is used for dynamic storage modulus, which provides a measure of the hardness of the rubber composition.

TABLE 2

| | Comp. | Comp. | Comp. | Comp. | Comp. | Comp. |
|---|---|---|---|---|---|---|
| | A | B | C | D | E | F |
| MH | 14.33 | 12.43 | 16.49 | 13.87 | 18.38 | 15.68 |
| (160 C.) | | | | | | |
| T50 | 2.9 | 3.55 | 3.87 | 4.38 | 2.84 | 3.13 |
| M50 (RT) | 1.09 | 0.84 | 1.09 | 0.90 | 1.21 | 1.09 |
| M300 | 11.11 | 5.37 | 8.46 | 6.29 | 10.45 | 8.45 |
| T_{B} | 585 | 742 | 651 | 700 | 594 | 622 |
| E_{B} | 25.7 | 23.7 | 26.4 | 24.1 | 26.8 | 25.2 |
| 25 C. | 5.86 | 6.20 | 5.87 | 5.53 | 6.78 | 6.39 |
| E′ (2%) | | | | | | |
| 25 C. | 0.175 | 0.167 | 0.174 | 0.166 | 0.151 | 0.160 |
| tan δ (2%) | | | | | | |

Compositions C, E and F exhibited M50 and M300 moduli comparable to reference composition A that excludes silica thus showing that addition free sulfur with additional accelerator can return modulus of a silica-containing composition (e.g., 20-30 phr) to near that of a carbon black composition. More specifically, Compositions C, E and F had a silane coupling agent:free sulfur:total accelerator ratio of about 1:0.8:0.8, about 1:0.8:1 and about 1:0.65:0.9. Compositions C, E and F each had a M50 modulus equal to or greater than Composition A, and a M300 modulus respectively greater than 8 MPa and within about 24, about 6 and about 25 percent of that measured for Composition A.

Table 3 below lists the components of sample tread rubber compositions that were made to determine the composition properties at various loadings of silica, silane coupling agent, sulfur, and vulcanization accelerators. Composition G, as compared to Compositions H-M, is the reference compositions containing only carbon black filler and no silica. Compositions H-M contain varying ratio amounts of both carbon black and silica, e.g., 3:1 to 1:9. All of the charges are listed as parts per hundred rubber (phr). All of the compounded final sample stocks were sheeted and subsequently cured at 145° C. for 33 minutes.

TABLE 3

| | Comp. | Comp. | Comp. | Comp. | Comp. | Comp. | Comp. |
|---|---|---|---|---|---|---|---|
| Component | G | H | I | J | K | L | M |
| Natural Rubber | 65 | 65 | 65 | 65 | 65 | 65 | 65 |
| Butadiene Rubber | 35 | 35 | 35 | 35 | 35 | 35 | 35 |
| Carbon Black | 50 | 37.5 | 25 | 25 | 12.5 | 12.5 | 5 |
| Silica | 0 | 12.5 | 25 | 25 | 37.5 | 37.5 | 45 |
| Silane Coupling | 0 | 1 | 2 | 2 | 3 | 3 | 3.6 |
| Agent | | | | | | | |
| Sulfur | 1.1 | 1.3 | 1.1 | 1.5 | 1.1 | 1.7 | 1.8 |
| Accelerator 1 - | 0.8 | 0.95 | 0.8 | 1.09 | 0.8 | 1.24 | 1.31 |
| sulfenamide | | | | | | | |
| Accelerator 2 - | 0.2 | 0.36 | 0.83 | 0.51 | 1.14 | 0.67 | 0.76 |
| guanidine | | | | | | | |

Table 4 below lists the properties (e.g., tensile) after cure of the sample tread rubber compositions (Compositions G-M) of Table 3.

TABLE 4

| | Comp. | Comp. | Comp. | Comp. | Comp. | Comp. | Comp. |
|---|---|---|---|---|---|---|---|
| | G | H | I | J | K | L | M |
| MH (160 C.) | 16.16 | 16.16 | 14.39 | 16.86 | 16.35 | 20.97 | 23.66 |
| T50 | 3.21 | 2.84 | 2.96 | 3.60 | 3.80 | 3.90 | 4.36 |
| M50 (RT) | 1.28 | 1.24 | 1.15 | 1.23 | 1.07 | 1.31 | 1.28 |
| M300 | 10.43 | 10.35 | 7.79 | 9.38 | 6.01 | 9.41 | 8.51 |
| T_{B} | 26.1 | 26.6 | 25.1 | 25.7 | 24.0 | 25.6 | 23.7 |
| E_{B} | 642 | 654 | 686 | 637 | 736 | 633 | 616 |
| 25 C. E′ (2%) | 10.53 | 9.16 | 9.25 | 9.39 | 9.84 | 9.76 | 10.91 |
| 25 C. tan δ (2%) | 0.279 | 0.245 | 0.241 | 0.230 | 0.214 | 0.196 | 0.196 |
| Abradability | 0.0482 | 0.0544 | 0.0607 | 0.0568 | 0.0640 | 0.0531 | 0.0572 |
| (mg/J) | | | | | | | |

Compositions H, J, L and M exhibited M50 and M300 moduli comparable to reference composition G that excludes silica thus showing that addition free sulfur with additional accelerator can return modulus of a silica-containing composition to near that of a carbon black composition. More specifically, Compositions H, J, L and M had a silane coupling agent:free sulfur:total accelerator ratio of about 1:1.3:1.3, about 1:0.75:0.75, about 1:0.6:0.6 and about 1:0.5:0.5 for compositions containing a silica content of 10-50 phr. Compositions H, J, L and M had a M50 modulus about equal to or greater than Composition G, and a M300 modulus greater than 8.5 MPa and within 10 to 20 percent of that measured for Composition G. Specifically, Composition H respectively exhibited a M300 and M50 modulus within less than 1% and about 3% as compared to Composition G. Composition J respectively exhibited a M300 and M50 modulus within about 10% and about 4% as compared to Composition G. Composition L respectively exhibited a M300 and M50 modulus within about 10% and greater than about 2% as compared to Composition G. Lastly, Composition M respectively exhibited a M300 and M50 modulus within about 18% and equal as compared to Composition G.

In contrast, Compositions I and K exhibited a M300 less than 8 MPa and more than 25% less as compared to Composition G. Compositions I and K similarly exhibited lower M50 modulus as compared to Composition G, or more than 10% less as shown for Composition G. Compositions I and K had a silane coupling agent:free sulfur:total accelerator ratio of about 1:0.55:0.8 and about 1:0.35:0.65, showing that when a silane coupling agent to sulfur ratio dips below 1:0.6, even when total accelerator content is greater than free sulfur, modulus is undesirably reduced in silica-containing compositions as compared to the same compositions having silica replaced with carbon black as a filler.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

1. A heavy vehicle tire tread formed from a rubber composition, the rubber composition comprising a rubber component and, per 100 parts by weight of rubber, of:
a. a reinforcing filler comprising silica, the silica being present in less than 30 phr;
b. a silane coupling agent;
c. 0.5 to 2.5 phr sulfur;
d. 0.5 phr or more of a first vulcanization accelerator; and
e. optionally a second vulcanization accelerator;
wherein a ratio of the silane coupling agent to the sulfur to total accelerator content in the rubber composition is in the range of 1:0.6:0.6 to 1:1.4:1.4;
wherein a modulus 300% elongation of the tire tread is 8 MPa or more.

2. The heavy vehicle tire tread of claim 1, wherein the reinforcing filler comprises 28 phr or less of silica.

3. The heavy vehicle tire tread of claim 1, wherein the sulfur is present at 1-2 phr and the silane coupling agent is present at 0.8 to 4.5 phr.

4. The heavy vehicle tire tread of claim 1, wherein the first vulcanization accelerator is a sulfenamide, and the ratio of the sulfur to the sulfonamide is 1:0.65 to 1:1.2.

5. The heavy vehicle tire tread of claim 1, wherein the second vulcanization accelerator is present in an amount of 0.35 phr or more.

6. The heavy vehicle tire tread of claim 1, wherein the first vulcanization accelerator and the second vulcanization accelerator are present at a ratio from 1:1 to 4:1.

7. The heavy vehicle tire tread of claim 1, wherein a ratio of the silane coupling agent to the sulfur is from 0.75:1 to 3:1.

8. The heavy vehicle tire tread of claim 1, wherein the reinforcing filler further comprises carbon black, and the reinforcing filler comprises a ratio of the silica to the carbon black of from 1:1 to 12.5:1.

9. The heavy vehicle tire tread of claim 8, wherein the reinforcing filler comprises 1 to 35 phr of carbon black.

10. The heavy vehicle tire tread of claim 1, wherein the total content of the first vulcanization accelerator and the second vulcanization accelerator is in the range of 1.5 to 2.5 phr.

11. The heavy vehicle tire tread of claim 1, wherein the rubber component comprises 40 to 100 parts by mass of a natural rubber or a polyisoprene rubber.

12. The heavy vehicle tire tread of claim 11, wherein the rubber component further comprises a polybutadiene rubber or a polystyrene-butadiene rubber.

13. The heavy vehicle tire tread of claim 1, wherein the tire tread is a truck tire tread or a bus tire tread.

14. A heavy vehicle tire tread formed from a rubber composition, the rubber composition comprising a rubber component, the rubber component comprising 50-90 phr of natural rubber or a polyisoprene rubber and 5-50 phr of a diene elastomer, and, per 100 parts by weight of rubber, of:
a. a reinforcing filler comprising 30-50 phr of silica;
b. 2-4 phr silane coupling agent;
c. 1-2.5 phr sulfur;
d. 1 phr or more of a first vulcanization accelerator; and
e. a second vulcanization accelerator;
wherein a ratio of the silane coupling agent to the sulfur to total accelerator content in the rubber composition is in the range of 1:0.4:0.4 to 1:0.8:0.8;
wherein a modulus 300% elongation of the tire tread is 8 MPa or more.

15. The heavy vehicle tire tread of claim 14, wherein the reinforcing filler comprises 35 phr or less of carbon black.

16. The heavy vehicle tire tread of claim 14, wherein the first vulcanization accelerator and the second vulcanization accelerator are present at a ratio from 1.2:1 to 2.5:1.

17. The heavy vehicle tire tread of claim 14, wherein the primary accelerator is a sulfenamide, and the ratio of the sulfur to the sulfenamide is 1:0.6 to 1:0.9.

18. The heavy vehicle tire tread of claim 17, wherein the sulfenamide is present at 1-1.5 phr.

19. The heavy vehicle tire tread of claim 14, wherein the sulfur is present at 1.5-2 phr and the silane coupling agent is present at 2.8 to 3.8 phr.

20. The heavy vehicle tire tread of claim 14, wherein the total content of the first vulcanization accelerator and the second vulcanization accelerator is in the range of 1.5 to 2.5 phr.
